(19) United States
(12) Patent Application Publication
(10) Pub. No.: US 2019/0029219 A1
(43) Pub. Date: Jan. 31, 2019

(54) Ground Stake With Raised Signal

(71) Applicant: Daniel Harry Young, Glendale, AZ (US)

(72) Inventor: Daniel Harry Young, Glendale, AZ (US)

(21) Appl. No.: 16/047,193

(22) Filed: Jul. 27, 2018

Related U.S. Application Data
(60) Provisional application No. 62/605,051, filed on Jul. 31, 2017.

(51) Int. Cl. A01K 3/00; G08B 7/06

(52) U.S. Cl. CPC A01K 3/00; G08B 7/06

(57) ABSTRACT

An enhanced ground stake provides a ground stake for restraining a dog or other animal that improves ability to relocate and find an unattended stake in wooded or grassy areas after returning from a walk or hunt, alerts others to the location of an unattended stake in the ground and potential tripping hazard, and provides an indication of whether a dog is still attached to the stake.

### PRIORITY CLAIM

Applicant hereby claims priority under 35 USC § 119 to provisional U.S. patent application Ser. No. 62/605,051, filed Jul. 31, 2017, entitled “Ultimate Dog Stake.”

The entire contents of the aforementioned application are herein expressly incorporated by reference.

### FIELD

The present innovations generally relate to a ground stake for securing a dog, or other pets or animals to a certain confined area, and more particularly to a ground stake having a swivel connector for attaching the pet or animal and a raised flag or other signal for improved identification to the staked location in outdoor environments. While discussed in the context of a dog stake below, the disclosure is not so limited and it will be understood to be useful in conjunction with other animals that need to be restrained.

### BACKGROUND

Mankind is thought to have domesticated dogs nearly 15,000 years ago and since that time dogs have been keep for pets and work, including hunting and herding. In order to control or confine dogs in a domestic or working environments people have developed various devices to keep dogs by their side and prevent their dogs from leaving a confined area where a distraction may otherwise draw the dog away. These devices range from simple tools, such as, dog crates and leashes that physically limit the dogs movement to more high tech devices such as electronic fences which train the dog to not to leave a defined area. These devices have limitations—namely, crates are large and provide limited range of movement, leashes typically can provide greater movement but need to be held by a person and electronic fences require training the dog to stay in a specific visually identifiable area and they cannot readily be moved to new locations without retraining the dog. Another option for confining or restricting a dog's movement is a ground stake, which can allow a dog greater freedom of movement, readily be moved from location to location, and since it can be fixed to the ground does not require constant human interaction. Ground stake are particularly useful where the dog may be tied in a location for some extended time, such as, a campsite or park, or where the dog's owner needs their hands free such as for hunting. While ground stakes are prevalent, one issue with know stakes is that since they are fixed to the ground they can become easily lost in wooded or tall grass areas if not immediately remove once the dog is unhooked. This is a common situation in hunting situations or field contests. For example, in using dogs for hunting and retrieving, the dog may frequently be restrained during the hunt and then released to retrieve the animal. Upon the dog's return it is often difficult to relocate the stake especially in tall grass. Stakes left behind in the field because they could not be relocated result in financial loss and waste, and the creation of hazards and dangerous conditions. For example, people have been known to run over their own stakes with a vehicle when returning to the area potentially damaging the vehicle, lost stakes create a tripping hazard for others traveling through the area, and unseen stakes in farmer's fields are especially dangerous for workers and farm equipment. For the forgoing reasons, there is a need for a ground stake that can be more easily identified and retrieved.

### SUMMARY

The present disclosure solves the above needs and deficiencies with known dog stakes by providing a ground post for securing a dog and having a pivotably attached offset extension flag. The present disclosure provides a dog stake for staking a dog to the ground wherein the stake comprises a ground post extending from a lower portion to an upper portion, the lower portion being adapted to be secured in the ground and the upper portion being adapted to receive a swivel connector, the swivel connector being rotatably attached to the upper portion of the ground post and having at least one radial extending portion forming an attachment lug for attaching a dog and a vertically signal extension rod connected at a lower end to the swivel connector and extending to an upper end providing a signal. In alternate embodiments of the disclosure, the swivel connector has an attachment lug extending radially from one side of the swivel connector and has a signal rod attachment mount or point radially extending from another side of the swivel connector so that a longitudinal axis of the signal rod is preferably parallel to but offset from a longitudinal axis of the stake ground shaft or post. In various other embodiments, the signal may be a flag, light and sound emitter. In yet other embodiments, the lower portion of the ground shaft or post may be adapted with various means to assist in attaching to the device to the ground including a foot plate to help the user push the stake into the ground, or the lower portion of the stake may be formed in corkscrew shape to permit the user to screw the stake into the ground. In yet other embodiments the swivel connector may be formed as a clamp so that the user may clamp the signal rod and signal to their own stake or other structure or device. In a simplified embodiment, the attachment lug and signal rod attachment point or mount may alternatively be fixedly attached directly to the ground stake post.

While the disclosure above and the detailed disclosure below is presented herein in the context of a dog stake, it will be understood by those of ordinary skill in the art that the concepts may be applied to other types of animals or pet stakes in various ways where there is a beneficial advantage to see, find and relocate the ground stake and also visualize from a distance whether there is animal tied to the stake. With the foregoing overview in mind, specific details will now be presented, bearing in mind that these details are for illustrative purposes only and are not intended to be exclusive.

### BRIEF DESCRIPTION OF THE DRAWINGS

The accompanying drawings illustrate various non-limiting examples and innovative aspects of the ground stake with raised signal in accordance with the present description:

FIG. 1 shows an isometric view of one embodiment of the ground stake with raised signal; and

FIG. 2 shows an exploded view of one embodiment of the ground stake with raised signal.

### DETAILED DESCRIPTION

In simplified overview, an improved ground stake is described herein for providing a means of securing an animal in an area of the woods or field.

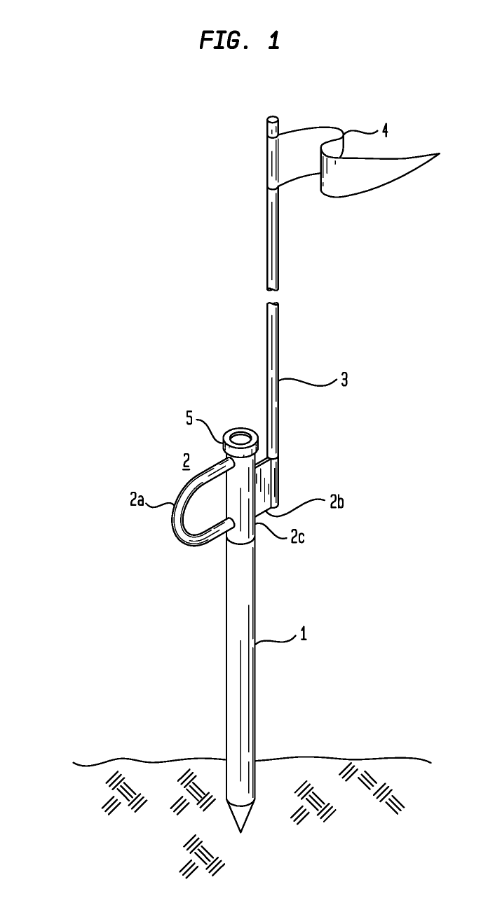

FIG. 1 illustrates one example arrangement of the improved ground stake with a swivel signal attachment for use in restricting a dog, pet or other animal to a confined area such as a dog park, field or hunting area. The ground stake is preferably in the form of a post (1) having a rotatably attached swivel connector (2), a locking flange (5), and a signal extension rod (3) holding a signal (4).

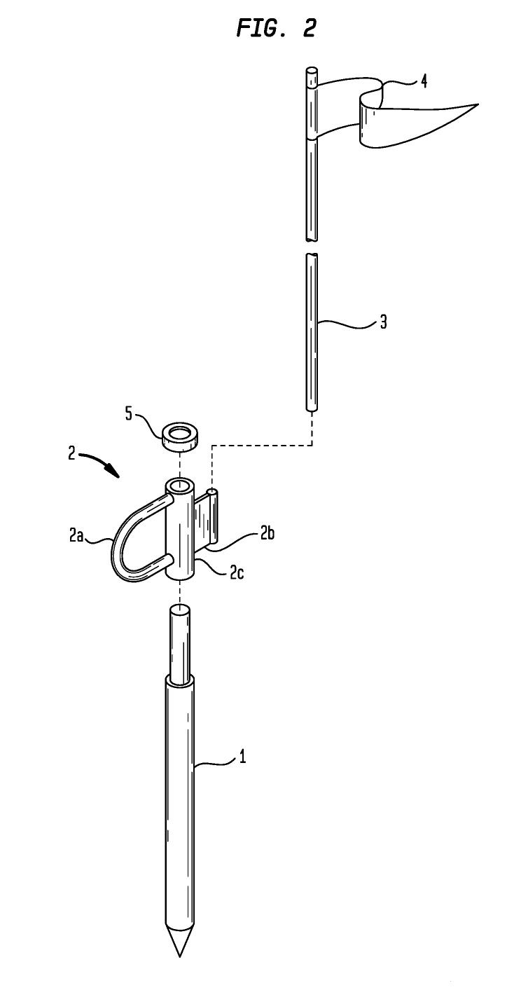

In a preferred embodiment the post (1) is an elongated metal post or rod constructed from steel or aluminum extending from a lower portion to an upper portion. The post (1) can be various lengths depending on the animal to be secured but is commonly about 24 inches for securing a dog. The lower portion of the post (1) is preferably adapted to be received in the ground. As shown in FIG. 1, the lower and of the post (1) is formed with a point so that the post can be more easily driven into the ground. In alternate arrangements, the lower and of the post (1) may be formed in a corkscrew or with barbs as necessary depending on the type of soil where the dog or animal is to be staked (e.g., sand, clay, peat or loam). Referring to FIG. 2 which illustrates and exploded view of one embodiment of the ground stake, the upper portion of the post is preferably formed or milled so the post diameter at the upper portion is narrower than the post diameter of the lower portion forming a seat or sill for supporting the swivel connector (2). In alternate embodiments, the post (1) may have a constant diameter and include a circumferential flange for supporting the swivel connector (2) on the upper portion of the post (1).

Referring to FIGS. 1 and 2, the swivel connector (2) is preferably formed of the same metal as the post (e.g., steel or aluminum) and has a sleeve or cylindrical main body section (2c), an attachment lug (2a) and a signal rod mount or attachment (2b). The sleeve or main body section (2c) has a central void with an internal diameter slightly larger than the external diameter of the upper portion of the post (1). In this way the swivel connector (2) can be received on the upper portion of the post (1) and rotate or swivel around the post (1). The swivel connector (2) is preferably supported at a lower end by resting on the sill, seat or flange as described above and secured at an upper end by a locking flange (5) fixed to the upper portion of the post (1) by welding or threaded attachment or the like. The locking flange (5) is preferably sized and formed of suitable material so that it can be used as a driving point to hammer the stake into the ground without being damaged.

Referring again to FIG. 1, the swivel connector (2) preferably has at least one radially extending portion forming an attachment lug or point (2a) and a signal rod attachment mount or point (2b). While in alternate embodiments the attachment lug (2a) and signal rod attachment point (2b) can be formed on the same radially extending portion, referring to FIG. 1, the attachment lug (2a) and signal rod attachment point (2b) preferably extend from opposite sides of the sleeve or main body section (2c). Alternatively, in some simplified embodiments, the attachment lug (2a) and (signal rod attachment point (2b) may be fixedly attached directly to post (1); in this simplified embodiment there is no main body portion (2c) that rotates around the upper portion of post (1) and the post (1) may be a single diameter with no flange, sill or seat.

The rod attachment mount or point (2b) is preferably adapted to receive a signal extension rod (3), which may be removably or fixedly attached to the signal rod attachment point (2b). The signal extension rod (2b) is preferably adapted at a lower end to be held in the signal rod attachment point (2b) and to receive and hold a signaling device (4) at the upper end. The signal extension rod may be a fixed or extendable length. While the extension rod may be any length, it is preferable that the extension be one to four feet in length to reach above tall grass or bushes. The extension rod (3) may be made from any substantial rigid material though it is desirable that it be flexible to prevent injury or breakage and it is preferable that the signal rod extension (3) be made of plastic or fiber glass.

Referring to FIGS. 1 and 2, a signal device (4) is received on the upper end of the signal extension rod (3). In one embodiment, the signal device (4) is shown as a flag but may be any device that is useful for the user of the stake to relocate the stake after leaving the area. Accordingly, in various scenarios the signal device may alternatively or in combination also include a sound emitter (e.g., for use by those who are sight impaired), or light emitter (for retrieval in the dark), and alternatively be remotely activate so the user may activate the light or sound only when needed.

Referring to FIG. 1, in the present disclosure the signal extension rod (3) and signal (4) are advantageously in an offset position from post (3) and locking flange (5). This arrangement permits the user to readily hammer the stake into the ground without impediment from the signal extension rod. Once the stake is secured in the ground and an animal such as a dog is attached by leash or chain, the swivel connector (2) will swivel and the signal (4) will move and rotate around the stake as the dog moves, due to the offset between the extension rod (3) and the post (1). This feature can both help to locate the stake and serve as an indicator that the dog is still attached to the stake even from a distance.

It should be understood that this description (including the figures) is only representative of some illustrative embodiments. For the convenience of the reader, the above description has focused on representative samples of all possible embodiments, and samples that teach the principles of the disclosure. The description has not attempted to exhaustively enumerate all possible variations. That alternate embodiments may not have been presented for a specific portion of the disclosure, or that further undescribed alternate embodiments may be available for a portion, is not to be considered a disclaimer of those alternate embodiments. One of ordinary skill will appreciate that many of those undescribed embodiments incorporate the same principles of the disclosure as claimed and others are equivalent.

What is claimed is:

1. A ground stake comprising:
a post wherein the post extends from a lower portion to an upper portion, the lower portion adapted to be placed in the ground;
a swivel connector wherein the swivel connector has a main body portion adapted to be rotatable received on the upper portion of the post, and wherein the main body portion is adapted to rotate around a longitudinal axis of the post, and wherein a first extension portion and a second extension portion extending radially from the main body portion in a direction away from the longitudinal axis of the post, wherein the first extension portion comprises an attachment lug for securing a animal and the second extension portion comprises a signal rod attachment point;
a signal extension rod wherein the signal extension rod extends from a lower portion to an upper portion, the lower portion of the signal extension rod being attached to the signal rod attachment point of the swivel connector, and wherein a longitudinal axis of the signal extension rod is radially offset from the longitudinal axis of the post; and
a signal attached to the upper portion of the signal extension rod.

2. The ground stake of claim 1, wherein the lower portion of the post is formed in a point.

3. The ground stake of claim 1, wherein the lower portion of the post is formed in a screw shape.

4. The ground stake of claim 1, wherein the signal is a flag.

5. The ground stake of claim 1, wherein the signal is a light.

6. The ground stake of claim 1, wherein the signal is a sound emitter.

7. The ground stake of claim 5, wherein the light may be remotely activated.

8. The ground stake of claim 6, wherein the sound emitter may be remotely activated.

9. The ground stake of claim 1, wherein the attachment lug is a u-shaped radial extension.

10. The ground stake of claim 1, wherein the post is composed of metal and the signal extension rod is composed of one of plastic or fiberglass.

11. The ground stake of claim 1, further comprising a locking flange fixedly attached to the upper portion of the post.

12. The ground stake of claim 11, wherein the upper portion of the post has a first diameter and the lower portion of the post has a second diameter, wherein the first diameter is smaller than the second diameter and wherein a sill is formed at the junction of the upper and lower positions of the post whereby the sill supports the swivel connector.

13. The ground stale of claim 1, wherein the attachment lug and the signal rod attachment point extend radially from opposite sides of the main body portion.

14. A ground stake comprising:
a metal post from one to two feet in length wherein the post extends from a lower portion having a first diameter to an upper portion having a second diameter, the first diameter is greater than the second diameter, a sill is formed at a junction of the lower portion and the upper portion, and the lower portion ends in a pointed portion;
a metal swivel connector wherein the swivel connector has a main body portion formed as a sleeve having an inner diameter sized to rotatably receive the second diameter of the post and adapted to rotate around a longitudinal axis of the post, and wherein a first extension portion and a second extension portion extending radially in a range from one to three inches away from the longitudinal axis from opposing sides of the main body portion, the first extension portion comprising an attachment lug for securing an animal and the second extension portion comprises a signal rod attachment point;
a locking flange adapted to be received and secured on the upper portion of the metal post;
a signal extension rod in the range of one to four feet in length and composed of at least one of fiberglass or plastic wherein the signal extension rod extends from a lower portion to an upper portion, the lower portion of the signal extension rod being attached to the signal rod attachment point of the swivel connector, and wherein a longitudinal axis of the signal extension rod is radially offset from the longitudinal axis of the post; and
a signal flag attached to the upper portion of the signal extension rod.
